(19) United States
(12) Patent Application Publication
(10) Pub. No.: US 2011/0303780 A1
(43) Pub. Date: Dec. 15, 2011

(54) WEBBING TAKE-UP DEVICE

(75) Inventors: Yoshiaki MAEKUBO, Aichi-ken (JP); Masaru UKITA, Aichi-ken (JP); Wataru YANAGAWA, Aichi-ken (JP)

(73) Assignee: KABUSHIKI KAISHA TOKAI-RIKA-DENKI-SEISAKUSHO, Aichi-ken (JP)

(21) Appl. No.: 13/158,641

(22) Filed: Jun. 13, 2011

(30) Foreign Application Priority Data
Jun. 14, 2010 (JP) 2010-135163

(51) Int. Cl. B60R 22/28; B60R 22/34

(52) U.S. Cl. 242/379.1

(57) ABSTRACT

A sleeve is fitted in a spool so as to be arranged coaxially with the spool. A fit-insertion hole including plural female splines is formed on a cylindrical inner side of the sleeve coaxially with an axial line of the sleeve. A fit-insertion portion, which is fit-inserted in the fit-insertion hole, of a sub torsion shaft is coaxial with an axial line of the sub torsion shaft and provided with plural male splines formed on an outer peripheral side of the fit-insertion portion. As a result of rotational displacement of the sleeve about the axial line thereof and regulation of rotation of the sub torsion shaft, so an axial center of the fit-insertion portion is made to coincide with an axial center of the fit-insertion hole, a fit-insertion portion side of the sub torsion shaft is fixed by a fixing mechanism with respect to the sleeve.

### CROSS-REFERENCE TO RELATED APPLICATION

This application claims priority under 35 USC 119 from Japanese Patent Application No. 2010-135163 filed Jun. 14, 2010, the disclosure of which is incorporated by reference herein.

### BACKGROUND OF THE INVENTION

1. Field of the Invention

The present invention relates to a webbing take-up device in which a torsion shaft is assembled to a spool.

2. Related Art

There is known a webbing take-up device in which two energy-absorbing members which are a main shaft and a sub shaft as torsion shafts are arranged inside a spool (for example, refer to Japanese Patent Application Laid-Open (JP-A) No. 2009-113551). Those main shaft and sub shaft are arranged coaxially with the spool, and if axis positional accuracy thereof are enhanced, satisfactory drawing-out feeling of a webbing belt is obtained.

However, at a time when the main shaft and the sub shaft are each held by an intermediate portion in the axial direction in the spool, restriction is imposed on a shape of a portion to be held of the torsion shaft for the purpose of securing a region for the webbing belt made to pass through the spool. Thus, it is difficult to enhance the axis positional accuracy of the torsion shaft with respect to the spool on a side of the intermediate portion in the axial direction in the spool.

### SUMMARY OF THE INVENTION

In consideration of the above-mentioned facts, the present invention has an object to provide a webbing take-up device capable of enhancing an axis positional accuracy of a torsion shaft with respect to a spool in a case where one side end in the axial direction of the torsion shaft is held by the intermediate portion in the axial direction in the spool.

A webbing take-up device according to the first aspect of the present invention, includes: a spool formed in a cylindrical shape, around which a webbing belt is taken up in a layered manner; a torsion shaft accommodated in an axial center portion of the spool and arranged along an axial direction of the spool, the torsion shaft including: at one end portion of the torsion shaft in the axial direction, a held portion that is held at an intermediate portion of the spool in the axial direction, and at the other end portion of the torsion shaft in the axial direction, which is at a side opposite to the held portion, a fit-insertion portion which is coaxial with an axial line of the torsion shaft, a plurality of male splines being formed at an outer peripheral side of the fit-insertion portion; a sleeve formed in a cylindrical shape and arranged coaxially with the spool, the sleeve having a fitted-in portion which is fitted into the spool from a side which is at a side where the fit-insertion portion is arranged at the torsion shaft, a fit-insertion hole being formed in an inner side of the sleeve, the fit-insertion hole being coaxial with an axial line of the sleeve, and a plurality of female splines being formed at an inner peripheral surface of the fit-insertion hole, and the fit-insertion portion of the torsion shaft being fit-inserted in the fit-insertion hole; and a fixing section that is capable of fixing the fit-insertion portion of the torsion shaft to the sleeve in a state in which the sleeve is rotationally displaced about the axial line of the sleeve and rotation of the torsion shaft is regulated so that an axial center of the fit-insertion portion is made to coincide with an axial center of the fit-insertion hole.

In the webbing take-up device according to the first aspect of the present invention, the torsion shaft is accommodated in the axial center portion of the spool, and arranged along the axial direction of the spool, and the held portion, which is provided at the one end portion in the axial direction, is held by the intermediate portion axial direction in the spool. Further, the fit-insertion portion, which is provided at the other end portion opposed to the held portion in the axial direction of the torsion shaft is coaxial with the axial line of the torsion shaft and provided with the plural male splines formed on the outer peripheral side of the fit-insertion portion. Meanwhile, the fitted-in portion of the cylindrical sleeve is fitted in the spool from the side at which the fit-insertion portion is arranged at the torsion shaft, and the sleeve is arranged coaxially with the spool. In the sleeve the fit-insertion hole is formed on the cylindrical inner side of the sleeve coaxially with the axial line of the sleeve, and the plural female splines are formed on the inner peripheral surface of the fit-insertion hole. The fit-insertion portion of the torsion shaft is fit-inserted in the fit-insertion hole.

At the time of assembly of the torsion shaft, under a state in which the fit-insertion portion of the torsion shaft is fit-inserted in the fit-insertion hole of the sleeve, when the sleeve is rotationally displaced about the axial line thereof and rotation of the torsion shaft is regulated, respective component forces of forces by which the male splines of the fit-insertion portion are respectively disengaged (gone) from the female splines of the fit-insertion hole in accordance with the rotational displacement of the sleeve cause the fit-insertion portion to be displaced (subjected to centering) in a direction that the axial center of the fit-insertion portion coincides to the axial center of the fit-insertion hole. In the aspect of the present invention, under a state in which the sleeve is rotationally displaced about the axial line thereof and the rotation of the torsion shaft is regulated and hence the axial center of the fit-insertion portion is made to coincide with the axial center of the fit-insertion hole, the fit-insertion portion side of the torsion shaft can be fixed to the sleeve by the fixing section. Thus, the fit-insertion portion side of the torsion shaft is fixed to the sleeve by the fixing section in the state described above, and hence the torsion shaft is maintained in a state in which the torsion shaft is arranged coaxially with the sleeve, in other words, arranged coaxially with the spool.

The webbing take-up device according to the second aspect of the present invention, in the constitution of the first aspect, the device further includes: insertion grooves formed inside the spool at one side in the axial direction and extending in the axial direction of the spool, the one side being a side from which the fitted-in portion of the sleeve is fit in the spool; engagement grooves formed inside the spool and extending in the axial direction of the spool, the engagement grooves being shifted about an axis of the spool with respect to the insertion grooves, and the engagement grooves being formed at portions further than the insertion grooves toward the other side in the axial direction; engagement surfaces formed inside the spool, the engagement surfaces forming terminal end portions of the engagement grooves at the one side in the axial direction; and engagement protrusions provided on the held portion of the torsion shaft, the engagement protrusions being put into an engaged state in which the engagement protrusions face the engagement surfaces and abut with lateral side surfaces of the engagement grooves by causing the torsion shaft to be rotated relatively to the spool about an axis of the torsion shaft in a state in which the held portion is inserted in the spool and has passed through the insertion grooves.

In the webbing take-up device according to the second aspect of the present invention, the insertion grooves are formed inside the spool at one side in the axial direction and extend in the axial direction of the spool, the one side is a side from which the fitted-in portion of the sleeve is fit in the spool.

Meanwhile, the engagement grooves are formed inside the spool and extend in the axial direction of the spool, the engagement grooves are shifted about an axis of the spool with respect to the insertion grooves, and the engagement grooves are formed at portions further than the insertion grooves toward another side in the axial direction. The engagement surfaces are formed inside the spool, the engagement surfaces form the terminal end portions of the engagement grooves at the one side in the axial direction.

Further, the engagement protrusions are provided on the held portion of the torsion shaft, the engagement protrusions are into an engaged (caught) state in which the engagement protrusions face the engagement surfaces and abut with lateral side surfaces of the engagement grooves by causing the torsion shaft to be rotated relatively to the spool about an axis of the torsion shaft under a state in which the held portion is inserted in the spool and passes over the insertion grooves.

At the time of assembly of the torsion shaft, under the state in which the fit-insertion portion of the torsion shaft is fit-inserted in the fit-insertion hole of the sleeve, when the sleeve is rotationally displaced about the axial line thereof, the torsion shaft is rotated in accordance therewith. Thus, the engagement protrusions of the torsion shaft can be engaged (caught) in the spool. Further, when the engagement protrusions of the torsion shaft are engaged in the spool, such a state is obtained (reached) that the sleeve is rotationally displaced about the axial line thereof and the rotation of the torsion shaft is regulated. As a result, the axial center of the fit-insertion portion can be made to coincide with the axial center of the fit-insertion hole. That is, the engagement protrusions of the torsion shaft are engaged in the spool, and successively, the torsion shaft can be arranged coaxially with the sleeve.

As described hereinabove, the webbing take-up device according to the first aspect of the present invention provides an excellent effect capable of enhancing the axis positional accuracy of the torsion shaft with respect to the spool.

The webbing take-up device according to the second aspect of the present invention provides such an excellent effect that the engagement protrusions of the torsion shaft are engaged in the spool, and successively, the torsion shaft can be arranged coaxially with the sleeve.

### BRIEF DESCRIPTION OF THE DRAWINGS

Embodiments of the invention will be described in detail with reference to the following figures, wherein:

FIG. 1 is a cross-sectional view of a webbing take-up device according to an embodiment of the present invention;

FIG. 2 is an exploded perspective view of a main part of the webbing take-up device according to the embodiment of the present invention;

FIGS. 3A and 3B are functional diagrams for explaining an effect of coaxial arrangement of a sub torsion shaft and a sleeve; specifically, FIG. 3A illustrates a state in which a fit-insertion portion of the sub torsion shaft is inserted in a fit-insertion hole of the sleeve, and FIG. 3B illustrates a state in which an axial center of a fit-insertion portion is made to correspond to an axial center of the fit-insertion hole as a result of rotational displacement of the sleeve about an axial line thereof and regulation on rotation of the sub torsion shaft, each of which corresponds to an enlarged cross-sectional view taken along the line 3B-3B in FIG. 1;

FIG. 4 is a cross-sectional view taken along the line 5B-5B in FIG. 1, illustrating only a spool; and

FIGS. 5A and 5B are cross-sectional views for explaining a state in which the sub torsion shaft is assembled to the spool in FIG. 4; FIG. 5A illustrates a state in which the sub torsion shaft is inserted in the spool, and FIG. 5B illustrates a state in which the sub torsion shaft is rotationally displaced in the state of FIG. 5A, each of which corresponds to a cross-sectional view taken along the line 5B-5B in FIG. 1.

### DETAILED DESCRIPTION OF THE INVENTION

### Structure of an Embodiment

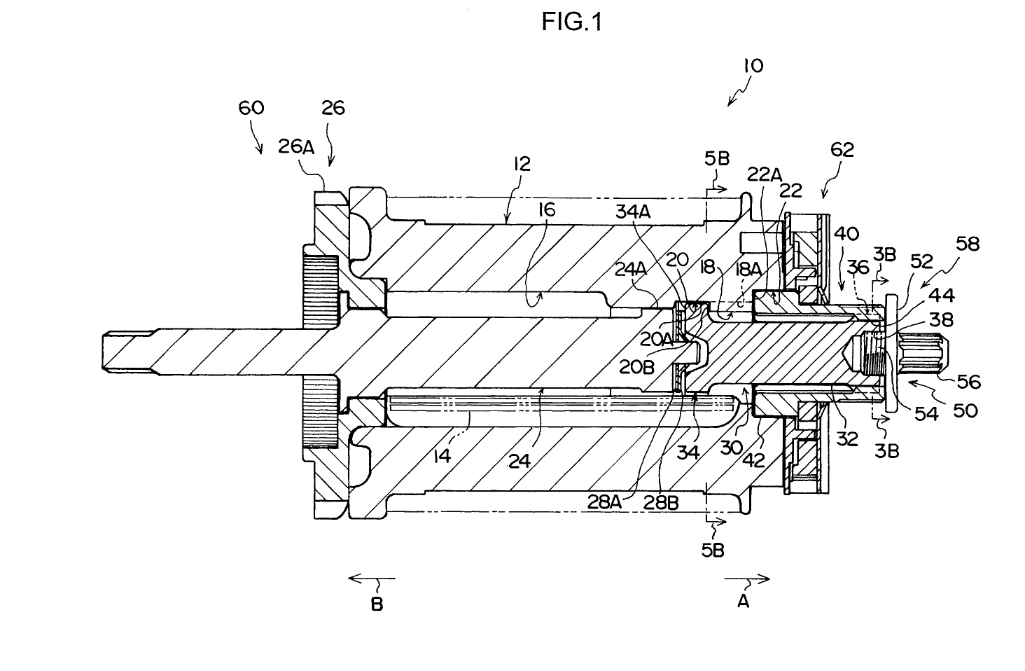

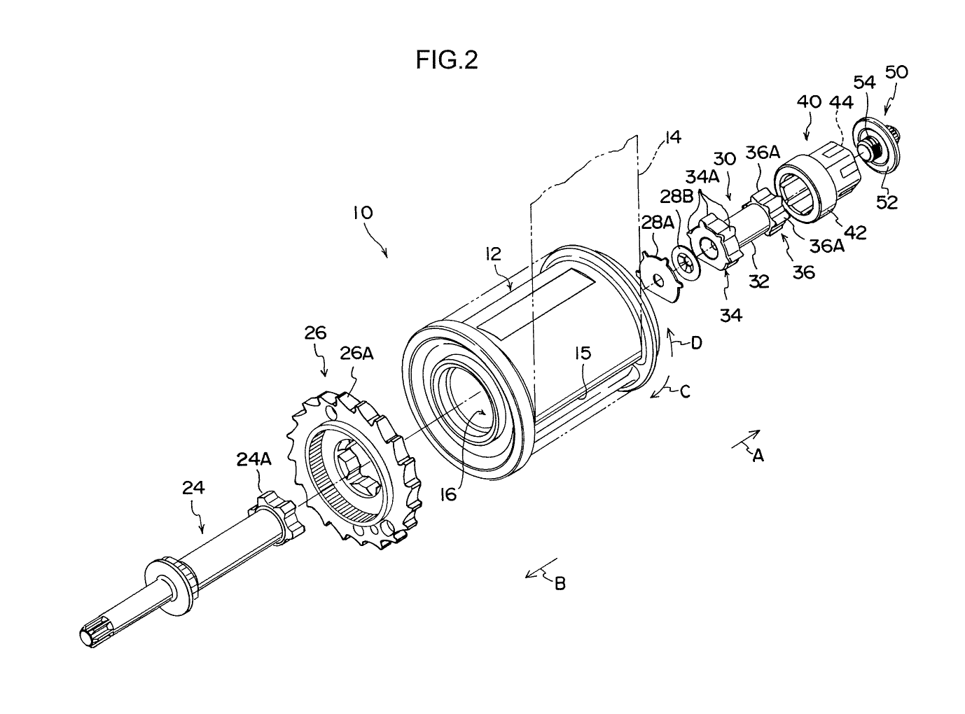

FIG. 1 is a cross-sectional view of a webbing take-up device 10 according to an embodiment of the present invention, and FIG. 2 is an exploded perspective view of a main part (shaft-assembled section) of the webbing take-up device 10. Note that, in the figures, one side in an axial direction of the spool 12 in the webbing take-up device 10 is indicated by an arrow A and another side in the axial direction of the spool 12 is indicated by an arrow B.

As illustrated in FIGS. 1 and 2, the webbing take-up device 10 according to this embodiment includes a spool 12 constituting a take-up shaft. The spool 12 is formed in a substantially cylindrical (tube) shape by die-casting, and the spool 12 includes both end portions in the axial direction which are rotatably supported by a frame (not shown in the drawings) fixed to a vehicle.

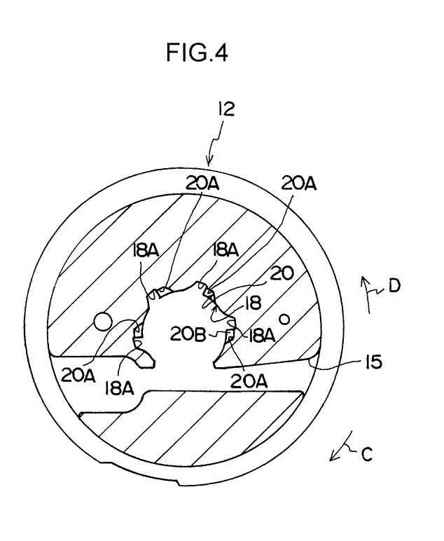

As illustrated in FIG. 2, the spool 12 is provided with a webbing-passing (webbing-inserted) hole 15 opening with an elongated rectangular shape along the axial direction. As illustrated in FIG. 4 which is a side cross-sectional view of the spool 12, the webbing-passing hole 15 is formed on an outer peripheral side relative to an axial center of the spool 12, and made to pass through the spool 12 along a chordal direction of the spool 12. An end portion on proximal-end-side of a long-belt-like webbing belt 14 is made to pass through the webbing-passing hole 15 illustrated in FIG. 2 in a retained state. The webbing belt 14 is taken up from the proximal end side thereof in a layered manner. When the spool 12 is rotated in a take-up direction (arrow C direction in FIG. 2), the webbing belt 14 is taken up on the spool 12. Further, when the webbing belt 14 is drawn out from the spool 12, the spool 12 is rotated in a drawing-out direction (arrow D direction of FIG. 2) in accordance therewith.

In the spool 12, a through hole 16 is formed so as to be through the spool 12 as an assembly hole at an axial center portion. An insertion hole 18 (refer to FIG. 1) is provided at a part, on one side in the axial direction, of the through hole 16 in the spool 12 (at the right side in the figure). As illustrated in FIG. 4 which is a cross-sectional view taken along the line 5B-5B of FIG. 1, illustrating only the spool 12, plural (four in this embodiment) insertion grooves 18A substantially trapezoidal in cross-section are formed on an outer peripheral side (an inner peripheral surface of the spool 12) of the insertion hole 18. The insertion grooves 18A extend in the axial direction of the spool 12 (refer to FIG. 1), and are arranged side by side at equal intervals in a circumferential direction of the spool 12.

As illustrated in FIG. 1, an engagement hole (catch-hole) 20 is formed at a location which is at the other side (at the left side in the figure) in the axial direction relative to the insertion grooves 18A (the insertion hole 18) in the through hole 16 in the spool 12. The engagement hole 20 is provided at a part, which is at the one side in the axial direction, of the through hole 16, but is provided at the other side relative to the insertion hole 18. As illustrated in FIG. 4, plural (four in this embodiment) engagement grooves (catch-grooves) 20A substantially trapezoidal in cross-section are formed on an outer peripheral side (an inner peripheral surface of the spool 12) of the engagement hole 20. Each engagement groove 20A extends in the axial direction of the spool 12 while partially shifting with respect to the insertion groove 18A about a spool axis (in the circumferential direction of the hole) (refer to FIG. 1), and communicate to the insertion groove 18A. The plural engagement grooves 20A are arranged at equal intervals in the circumferential direction of the spool 12. Further, as illustrated in FIG. 1, in the spool 12, an engagement surface (catch surface) 20B is formed at a terminal end portion on one side (at the right side in the figure) in the axial direction of each of the engagement grooves 20A. The engagement surface 20B is arranged at a boundary part between the insertion groove 18A and the engagement groove 20A in the cross-sectional view of FIG. 1.

Further, a sleeve-mount portion 22 is formed on an opposite side of the insertion hole 18 with respect to the engagement hole 20. The sleeve-mount portion 22 is formed in a circular shape as to have an inner peripheral shape coaxial with the axial center (central axis line) of the spool 12, and opens at one end portion in the axial direction of the spool 12. The inner peripheral shape of the sleeve-mount portion 22 is set to be sufficiently larger than an inner peripheral shape of the insertion hole 18. Thus, a bottom wall portion 22A is formed in the sleeve-mount portion 22 on a side of the insertion hole 18.

In the axial center portion of the spool 12, a main torsion shaft 24 and a sub torsion shaft 30 (those elements are to be understood as “energy-absorbing member” in a broad sense) which constitute a force limiter mechanism are accommodated and are arranged in line along the axial direction of the spool 12. Further, the sub torsion shaft 30 is such a member as to have a length in axial direction set to be shorter than that of the main torsion shaft 24, and a shift to the radial direction on the one end side in the axial direction of the sub torsion shaft 30 has a large influence on an inclination with respect to the axial direction in comparison with that of the main torsion shaft 24. In this embodiment, the sub torsion shaft 30 is a member having a structure of a “torsion shaft” according to a first aspect of the present invention.

The main torsion shaft 24 includes an end portion 24A held by an intermediate portion in the axial direction in the spool 12, the end portion 24A being on a side as to face the sub torsion shaft 30. Note that, although detail explanation will be omitted, the end portion 24A of the main torsion shaft 24 is provided with a projecting portion projecting to a side of the sub torsion shaft 30, and a washer 28A and a push nut 28B are mounted thereto.

A lock gear 26 constituting a first lock mechanism 60 on the other side in the axial direction of the spool 12 (at the left side in the figure) is attached in an intermediate portion in the axial direction of the main torsion shaft 24 so that the lock gear 26 is incapable of relative rotation with respect to the main torsion shaft 24. Ratchet teeth 26A as outer teeth are formed on an outer peripheral portion of the lock gear 26. Correspondingly to the ratchet teeth 26A, a lock plate (not shown in the drawings) also constituting the first lock mechanism 60 is provided at the frame (not shown in the drawings). The lock plate is capable of moving toward/away from the ratchet teeth 26A. Under a state in which the first lock mechanism 60 is actuated by an abrupt deceleration state of the vehicle or abrupt rotation of the spool 12 in the drawing-out direction, the lock plate meshes with the ratchet teeth 26A so as to a regulate rotation of the ratchet teeth 26A in the drawing-out direction.

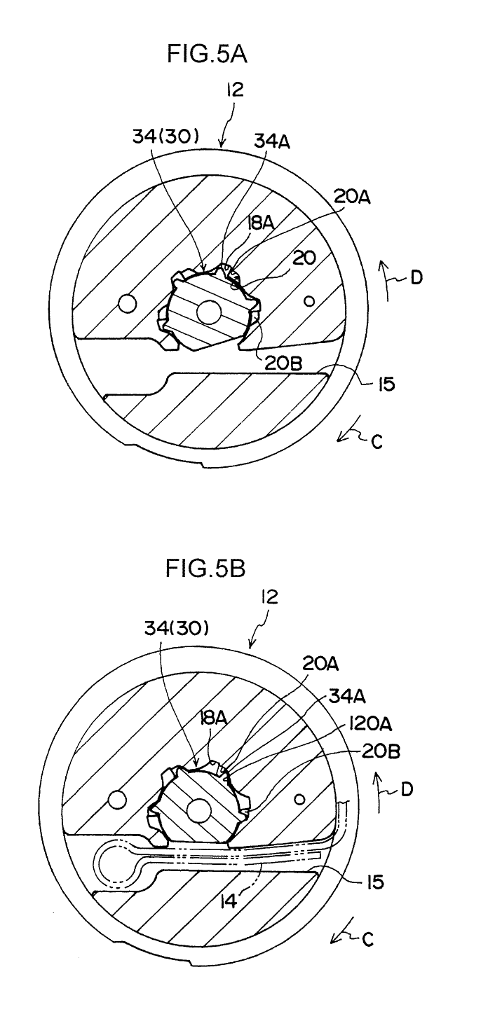

As illustrated in FIG. 2, the sub torsion shaft 30 includes a substantially cylindrical columnar body 32 arranged along the axial direction of the spool 12, and includes a held portion (a portion to be held) 34 at an end portion on a side facing the main torsion shaft 24 (at one end portion in the axial direction). The held portion 34 is larger in diameter than the body 32, and plural (four in this embodiment) substantially triangular-columnar engagement (catch) protrusions 34A are formed on an outer peripheral side of the held portion 34. The engagement protrusions 34A are arranged side by side at equal intervals in a circumferential direction of the sub torsion shaft 30. Further, as illustrated in FIG. 5B corresponding to a cross-sectional view taken along the line 5B-5B of FIG. 1, a part on an outer peripheral side of the held portion 34 is linearly cut out so that a passing portion for the webbing belt 14 in the intermediate portion in the axial direction in the spool 12 is secured. Thus, a cross-sectional shape of the held portion 34, in a case of cutting along a direction orthogonal to the axis, is made to be a non-point-symmetrical (point-asymmetrical) shape.

The sub torsion shaft 30 illustrated in FIG. 1 is held in an engaged state (a caught state) in which the engagement protrusions 34A face the engagement surfaces 20B of the engagement grooves 20A and are come in contact with side surfaces 120A (refer to FIG. 5B, side surfaces in drawing-out direction) of the engagement grooves 20A, thus the sub torsion shaft 30 is incapable of being removed (disengaged) from the spool 12. That is, in this state, the sub torsion shaft 30 is blocked a dropout from the spool 12 toward the one side in the axial direction (regulated in a thrust direction), and rotation of the spool 12 in the drawing-out direction with respect to the sub torsion shaft 30 is prevented. The held portion 34 is held in the intermediate portion in the axial direction in the spool 12.

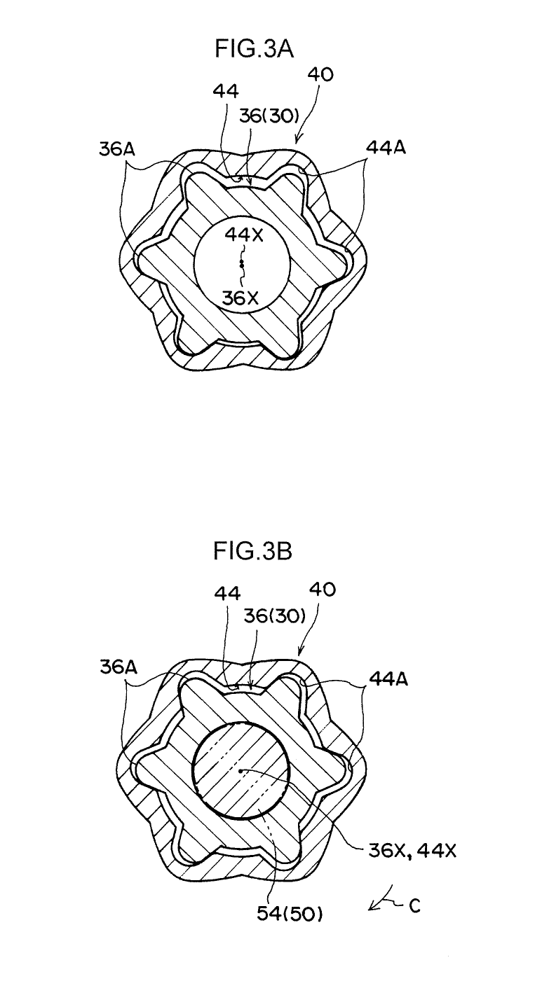

Meanwhile, as illustrated in FIG. 2, in the sub torsion shaft 30, a fit-insertion portion 36 is provided at an end portion at a side which is opposed to the held portion 34 in the axial direction. The fit-insertion portion 36 is coaxial with an axial line of the sub torsion shaft 30, and plural (six in this embodiment) male splines 36A are formed on an outer peripheral side of the fit-insertion portion 36 (“six-male-splines 36A” is coaxial with an axial line of the sub torsion shaft 30). As illustrated in FIG. 3B corresponding to an enlarged cross-sectional view taken along the line 3B-3B of FIG. 1, the male splines 36A of the fit-insertion portion 36 are formed in spline shape (curved-convex-like shape) toward the outer side in radial-direction on an outer peripheral side of a cross-sectional shape with cutting along the direction orthogonal to the axis of the sub torsion shaft 30.

As illustrated in FIG. 1, a sleeve 40 is mounted to the sub torsion shaft 30. The sleeve 40 is formed in a tube-like shape (refer to FIG. 2), and includes a fitted-in portion 42 to be fitted into the spool 12 at the other side. The fitted-in portion 42 is fitted into the spool 12 from a side at which the fit-insertion portion 36 is arranged in the sub torsion shaft 30, that is, from the one side, and hence the sleeve 40 is arranged coaxially with the spool 12. An outer shape of the fitted-in portion 42 is formed in a circular shape, and an outer diameter dimension of the fitted-in portion 42 is set to be substantially equal to (exactly, only a little smaller than) an inner diameter dimension of the sleeve-mount portion 22. That is, positioning in radial-direction is performed based on the outer diameter dimension of the fitted-in portion 42 and the inner diameter dimension of the sleeve-mount portion 22. Note that, in this embodiment, a side, on which the fitted-in portion 42 of the sleeve 40 is fitted in, in the spool 12 corresponds to the one side in the axial direction of the spool 12.

Further, on a tube inner side of the sleeve 40, a fit-insertion hole 44 coaxial with the axial line of the sleeve 40 (the sub torsion shaft 30) is formed at a side which is opposed to the fitted-in portion 42 in the axial direction. As illustrated in FIG. 3, the fit-insertion hole 44 along the axial direction of the sleeve 40 has an inner peripheral shape which is a correspondingly similarity shape to and only a little larger than an outer peripheral shape of the fit-insertion portion 36 of the sub torsion shaft 30, and has an inner peripheral surface at which plural (six in this embodiment) female splines 44A are formed. With this structure, the sub torsion shaft 30 is inserted in the sleeve 40, and the fit-insertion portion 36 of the sub torsion shaft 30 is fit-inserted (radial fitting) in the fit-insertion hole 44 of the sleeve 40.

Further, as illustrated in FIG. 1, under a state in which the sleeve 40 is mounted to the sub torsion shaft 30, a screw 50 (male threaded member) constituting a fixing section is attached to the sub torsion shaft 30. The screw 50 includes a flange portion 52. The flange portion 52 has an outer peripheral shape formed in a desk-like shape larger than the inner peripheral shape of the fit-insertion hole 44. On one end surface on of the flange portion 52, a shaft-like male threaded portion 54 is formed coaxially with the flange portion 52.

Meanwhile, on the fit-insertion portion 36 side of the sub torsion shaft 30, a threaded-hole portion 38 opening at an end surface portion at a side opposite to the body 32 is formed. The threaded-hole portion 38 is formed coaxially with the body 32. The male threaded portion 54 of the screw 50 is threadedly engageable with a female threaded portion of the threaded-hole portion 38. At an end portion, which is at a side opposite to the male threaded portion 54, of the flange portion 52, a knob portion 56 is formed coaxially with the flange portion 52 and the male threaded portion 54.

Under a state in which the male threaded portion 54 of the screw 50 is threadedly engaged with and fastened to the female threaded portion of the threaded-hole portion 38 of the sub torsion shaft 30, the flange portion 52 of the screw 50 and the engagement protrusions 34A of the sub torsion shaft 30 sandwich the sleeve 40 and a peripheral rim portion of the insertion hole 18 of the spool 12 so as to impart a fastening load in spool-axial direction. Simultaneously, a load is generated which attracts the sub torsion shaft 30 toward a screw 50 side. With the result, both ends in the axial direction of the sub torsion shaft 30 are fixed. That is, in this embodiment, a fixing mechanism 58 is formed as the fixing section including the screw 50, the threaded-hole portion 38 of the sub torsion shaft 30, the engagement protrusions 34A of the sub torsion shaft 30, and the rim portion of the insertion hole 18 of the spool 12. Thereby, the fixing mechanism 58 is capable of fixing a fit-insertion portion 36 side of the sub torsion shaft 30 with respect to the sleeve 40.

Note that, although detail explanation will be omitted, at a lateral side of the spool 12 also at an outer peripheral side of the sleeve 40, plural clutch members are arranged which constitute a second lock mechanism 62. That is, a rotator rotated integrally with the sleeve 40 is fitted to the sleeve 40, and a mechanism is provided, which engages directly or indirectly with the rotator and regulates a rotation of the rotator in the drawing-out direction. Further, in this embodiment, the second lock mechanism 62 is actuatable with interlocking with the first lock mechanism 60. For example, based on detected results obtained from a body-size detecting unit for detecting body-size information such as weight of a passenger seated on a seat provided with the webbing take-up device 10, the second lock mechanism 62 can be switched between an actuatable state and a non-actuatable state.

### Effects and Advantages of this Embodiment

Next, description is made of effects and operations of the above-mentioned embodiment.

First, brief description is made of functional effects and advantages of the webbing take-up device 10.

In the webbing take-up device 10, when the acceleration sensor of the first lock mechanism 60 has detected the abrupt deceleration state of the vehicle, or when a passenger's body abruptly moving toward a vehicle front side due to inertia generated by such abrupt deceleration abruptly pulls the applied webbing belt 14, thus then the spool 12 has been abruptly rotated in the drawing-out direction, first, the lock plate (not shown in the drawings) meshes with the ratchet teeth 26A of the lock gear 26 of the first lock mechanism 60. It causes to be a first locked state, in which a rotation of the lock gear 26 in the drawing-out direction is regulated. Regulating the rotation of the lock gear 26 in the drawing-out direction causes a rotation of the main torsion shaft 24 in the drawing-out direction to be regulated. Further, regulating the rotation of the main torsion shaft 24 in the drawing-out direction causes the rotation of the spool 12 in the drawing-out direction to be regulated. In this state, when a rotational force, which has a magnitude higher than that of torsional rigidity of the main torsion shaft 24, in drawing-out direction has been imparted to the spool 12, the main torsion shaft 24 is torsionally deformed. In accordance therewith, the rotation of the spool 12 is allowed, and energy is absorbed.

Meanwhile, when the second lock mechanism 62 has been actuated under a state in which the first lock mechanism 60 is actuated, it causes to be a second locked state in which the rotation of the rotator, which is rotated integrally with the sleeve 40, in the drawing-out direction is regulated. In the sleeve 40, the fit-insertion portion 36 of the sub torsion shaft 30 is inserted in the fit-insertion hole 44, and hence the fit-insertion portion 36 and the sleeve 40 are stopped from being rotated with respect to each other. Therefore, regulating the rotation of the sleeve 40 in the drawing-out direction together with the rotation of the rotator causes the rotation of the sub torsion shaft 30 in the drawing-out direction to be regulated. Further, since the sub torsion shaft 30 and the spool 12 are stopped from being rotated with respect to each other, regulating the rotation of the sub torsion shaft 30 in the drawing-out direction causes the rotation of the spool 12 in the drawing-out direction to be regulated. In this state, when a rotational force, which has a magnitude higher than that of the total sum of torsional rigidities of both the main torsion shaft 24 and the sub torsion shaft 30, in drawing-out-direction has been imparted to the spool 12, both the main torsion shaft 24 and the sub torsion shaft 30 are torsionally deformed. In accordance therewith, the rotation of the spool 12 is allowed, and the energy is absorbed.

Further, the second lock mechanism 62 is constituted so as to interlock with the first lock mechanism 60. In addition, for example, based on detected results obtained from the body-size detecting unit for detecting body-size information such as weight of a passenger seated on the seat provided with the webbing take-up device 10, the second lock mechanism 62 can switch between the actuatable state and the non-actuatable state. When the second lock mechanism 62 is brought into the actuatable state, the rotation of the spool 12 is allowed by the rotational force, which has the magnitude higher than that of the total sum of the torsional rigidities of both the main torsion shaft 24 and the sub torsion shaft 30, in drawing-out-direction. Meanwhile, when the second lock mechanism 62 is brought into the non-actuatable state, the rotation of the spool 12 is allowed by the rotational force, which has the magnitude higher than the torsional rigidity of the main torsion shaft 24, in drawing-out-direction. Therefore, a magnitude of the absorbable energy can be varied.

Next, description is made of the effects and operations of this embodiment by way of description of how to assemble the webbing take-up device 10 (assembly method for the sub torsion shaft 30). Note that, in the following, description is made of assembly steps after the main torsion shaft 24 and the first lock mechanism 60 has been assembled to the spool 12.

First, as illustrated in FIG. 5A, while the engagement protrusions 34A of the held portion 34 of the sub torsion shaft 30 are aligned with the insertion grooves 18A of the spool 12, the sub torsion shaft 30 illustrated in FIGS. 1 and 2 is inserted into the through hole 16 of the spool 12, and is made to pass through the insertion grooves 18A (refer to FIG. 1). At this time, the held portion 34 of the sub torsion shaft 30 illustrated in FIG. 1 is inserted to the vicinity of the push nut 28B in the engagement hole 20 so as to reach a position at which the engagement hole 20 is formed. Note that, the fit-insertion portion 36 side of the sub torsion shaft 30 is arranged so as to project from the spool 12.

Next, the fitted-in portion 42 of the sleeve 40 illustrated in FIGS. 1 and 2 is fitted into the sleeve-mount portion 22 of the spool 12 from a side at which the fit-insertion portion 36 of the sub torsion shaft 30 is arranged. In this manner, the sleeve 40 is arranged coaxially with the spool 12, and the fit-insertion portion 36 of the sub torsion shaft 30 is fit-inserted into the fit-insertion hole 44 of the sleeve 40. A slight gap exists between the fit-insertion hole 44 of the sleeve 40 and the fit-insertion portion 36 of the sub torsion shaft 30. Thus, as illustrated in FIG. 3A, an axial center 44X of the fit-insertion hole 44 and an axial center 36X of the fit-insertion portion 36 do not necessarily coincide each other, and hence, basically, are slightly shifted with respect to each other. Note that, although detail explanation will be omitted, the plural clutch components are assembled in advance onto the outer peripheral side of the sleeve 40 and integrated therewith (not shown in the drawings).

Next, in this state, the sleeve 40 is rotationally displaced at a predetermined angle with respect to the spool 12 in the take-up direction (refer to, for example, FIG. 1). At this time, in interlocking with the sleeve 40, as illustrated in FIG. 5B, the sub torsion shaft 30 is rotated at a predetermined angle relatively to the spool 12 (in the take-up direction) about an axis of the sub torsion shaft 30 itself. Due to this, it becomes an engaged (caught) state in which the engagement protrusions 34A of the held portion 34 of the sub torsion shaft 30 face the engagement surfaces 20B of the engagement grooves 20A and contacts with the side surfaces 120A in take-up direction of the engagement grooves 20A.

As described above, when the engagement protrusions 34A of the sub torsion shaft 30 are engaged (caught) inside the spool 12 and rotational torque continues to be imparted to the sleeve 40 illustrated, for example, in FIG. 1, it becomes a state in which the sleeve 40 is rotationally displaced about an axial line thereof and the rotation of the sub torsion shaft 30 is regulated. If there is completely no gap between the fit-insertion hole 44 of the sleeve 40 and the fit-insertion portion 36 of the sub torsion shaft 30, the rotation of the sleeve 40 is stopped. However, actually, as illustrated in FIGS. 3A and 3B, the slight gap exists between the fit-insertion hole 44 of the sleeve 40 and the fit-insertion portion 36 of the sub torsion shaft 30, and hence the sleeve 40 is slightly rotationally displaced. In this state, as illustrated in FIG. 3B, respective component forces by which the male splines 36A of the fit-insertion portion 36 are respectively disengaged (gone out) from the female splines 44A of the fit-insertion hole 44 (that is, the male splines 36A of the fit-insertion portion 36 being displaced relative to the female splines 44A of the fit-insertion hole 44 in a direction where the male splines 36A of the fit-insertion portion 36 are respectively gone out from the female splines 44A of the fit-insertion hole 44) in accordance with the rotational displacement of the sleeve 40 cause the fit-insertion portion 36 to be displaced (subjected to centering) to a direction that the axial center 36X of the fit-insertion portion 36 coincide with the axial center 44X of the fit-insertion hole 44.

In this state, with using a rotation stopping member (not shown in the drawings) the sleeve 40 illustrated in FIG. 1 is stopped from being rotated with respect to the spool 12, and the male threaded portion 54 of the screw 50 is fastened by being threadedly engaged with the female threaded portion of the threaded-hole portion 38 of the sub torsion shaft 30. In this manner, the flange portion 52 of the screw 50 and the engagement protrusions 34A of the sub torsion shaft 30 sandwich the sleeve 40 and the rim portion of the insertion hole 18 of the spool 12 to impart a fastening load in the axial direction of the spool. Simultaneously, the load is generated which attracts the sub torsion shaft 30 toward the screw 50 side. With the result, the both ends in the axial direction of the sub torsion shaft 30 are fixed. That is, as a result of rotational displacement of the sleeve 40 about the axial line thereof and regulation of the rotation of the sub torsion shaft 30 so that the axial center 36X (refer to FIG. 3B) of the fit-insertion portion 36 is made to coincide with the axial center 44X (refer to FIG. 3B) of the fit-insertion hole 44. In this state, the fit-insertion portion 36 side of the sub torsion shaft 30 is fixed by the fixing mechanism 58 with respect to the sleeve 40. Lastly, the rotation stopping member (not shown in the drawings) is detached.

As described above, the sub torsion shaft 30 is held in a state in which the sub torsion shaft 30 is arranged coaxially with the sleeve 40, in other words, arranged coaxially with the spool 12. That is, according to the webbing take-up device 10 in this embodiment, an axis positional accuracy of the sub torsion shaft 30 with respect to the spool 12 can be enhanced. Thereby, the shaft-assembled section including the spool 12 and the sub torsion shaft 30 is smoothly rotated, and hence satisfactory drawing-out feeling of the webbing belt 14 is obtained. Further, according to the webbing take-up device 10 in this embodiment, the engagement protrusions 34A of the sub torsion shaft 30 are engaged inside the spool 12, and successively, the sub torsion shaft 30 can be arranged coaxially with the sleeve 40.

Note that, in the above-mentioned embodiment, the sub torsion shaft 30 having an axial direction length set to be shorter than that of the main torsion shaft 24 is a member having the structure of the “torsion shaft” according to the first aspect of the present invention. However, for example, a torsion shaft having a longer axial direction length (the main torsion shaft) of the two torsion shafts, which are accommodated in the spool and aligned in line along the axial direction of the spools may be a member having the structure of the “torsion shaft” according to the first aspect of the present invention. Thereby, the axis positional accuracy of the longer torsion shaft with respect to the spool may be enhanced.

Further, in the above-mentioned embodiment, the engagement protrusions 34A provided at the held portion 34 of the sub torsion shaft 30 are held in the engaged state in which the engagement protrusion 34A faces, in the spool 12, the engagement surface 20B and is held in contact with the side surface 120A (refer to FIG. 5B) of the engagement groove 20A. However, the held portion of the torsion shaft may be held at the intermediate portion in the axial direction of the spool, for example, by being held in contact with a leading end portion of a pin-like member or the like, which passes through the spool in a radial direction in a press-fit state, as a rotation stopper and retainer (preventing it from being pulled out) for the torsion shaft.

Still further, in the above-mentioned embodiment, each of the numbers of the male splines 36A and the female splines 44A is set to six. However, the numbers of the male splines and the female splines are not limited to six.

Yet further, in the above-mentioned embodiment, the fixing mechanism 58 as the fixing section fixes the fit-insertion portion 36 side of the sub torsion shaft 30 with respect to the sleeve 40. However, as the fixing section capable of fixing the fit-insertion portion side of the torsion shaft with respect to the sleeve under the state in which the sleeve is rotationally displaced about the axial line thereof and the rotation of the torsion shaft is regulated and hence the axial center of the fit-insertion portion is made to coincide with the axial center of the fit-insertion hole, there may be provided another fixing section such as a fixing mechanism constituted so as to include the screw 50, the threaded-hole portion 38 of the sub torsion shaft 30, and a fixer that fixes the screw 50 to the sleeve 40.

What is claimed is:

1. A webbing take-up device comprising:
a spool formed in a cylindrical shape, around which a webbing belt is taken up in a layered manner;
a torsion shaft accommodated in an axial center portion of the spool and arranged along an axial direction of the spool, the torsion shaft including:
at one end portion of the torsion shaft in the axial direction, a held portion that is held at an intermediate portion of the spool in the axial direction, and
at the other end portion of the torsion shaft in the axial direction, which is at a side opposite to the held portion, a fit-insertion portion which is coaxial with an axial line of the torsion shaft, a plurality of male splines being formed at an outer peripheral side of the fit-insertion portion;
a sleeve formed in a cylindrical shape and arranged coaxially with the spool,
the sleeve having a fitted-in portion which is fitted into the spool from a side which is at a side where the fit-insertion portion is arranged at the torsion shaft,
a fit-insertion hole being formed in an inner side of the sleeve, the fit-insertion hole being coaxial with an axial line of the sleeve, and a plurality of female splines being formed at an inner peripheral surface of the fit-insertion hole, and
the fit-insertion portion of the torsion shaft being fit-inserted in the fit-insertion hole; and
a fixing section that is capable of fixing the fit-insertion portion of the torsion shaft to the sleeve in a state in which the sleeve is rotationally displaced about the axial line of the sleeve and rotation of the torsion shaft is regulated so that an axial center of the fit-insertion portion is made to coincide with an axial center of the fit-insertion hole.

2. The webbing take-up device of claim 1, further comprising:
insertion grooves formed inside the spool at one side in the axial direction and extending in the axial direction of the spool, the one side being a side from which the fitted-in portion of the sleeve is fit in the spool;
engagement grooves formed inside the spool and extending in the axial direction of the spool, the engagement grooves being shifted about an axis of the spool with respect to the insertion grooves, and the engagement grooves being formed at portions further than the insertion grooves toward the other side in the axial direction;
engagement surfaces formed inside the spool, the engagement surfaces forming terminal end portions of the engagement grooves at the one side in the axial direction; and
engagement protrusions provided on the held portion of the torsion shaft, the engagement protrusions being put into an engaged state in which the engagement protrusions face the engagement surfaces and abut with lateral side surfaces of the engagement grooves by causing the torsion shaft to be rotated relatively to the spool about an axis of the torsion shaft in a state in which the held portion is inserted in the spool and has passed through the insertion grooves.
